(19) United States
(12) Patent Application Publication
(10) Pub. No.: US 2017/0068238 A1
(43) Pub. Date: Mar. 9, 2017

(54) Method And Apparatus To Facilitate The Use Of Additive-Manufacturing Models

(71) Applicant: Wal-Mart Stores, Inc., Bentonville, AR (US)

(72) Inventors: Donald R. High, Noel, MO (US); John P. Thompson, Bentonville, AR (US); Robert C. Taylor, Rogers, AR (US); David C. Winkle, Bella Vista, AR (US); Michael D. Atchley, Springdale, AR (US)

(21) Appl. No.: 15/254,417

(22) Filed: Sep. 1, 2016

Related U.S. Application Data
(60) Provisional application No. 62/214,832, filed on Sep. 4, 2015.

(51) Int. Cl. G05B 19/4099; B29C 67/00; B33Y 99/00; B33Y 30/00

(52) U.S. Cl. CPC G05B 19/4099; B33Y 30/00; B29C 67/0088; B33Y 99/00; G05B 2219/35134; G05B 2219/49007

(57) ABSTRACT

A plurality of geographically-distributed retail shopping facilities each have at least one additive-manufacturing platform such as but not limited to a three-dimensional printer. A control circuit provides an additive-manufacturing facilitation service that includes providing a remote user with a choice between providing an additive-manufacturing model to one of the aforementioned additive-manufacturing platforms to permit an item to be manufactured for pickup by the remote user at that corresponding facility and downloading an additive-manufacturing model to permit the remote user to themselves use the additive-manufacturing model (for example, in conjunction with their own additive-manufacturing platform).

### CROSS-REFERENCE TO RELATED APPLICATION

This application claims the benefit of U.S. Provisional Application No. 62/214,832, filed Sep. 4, 2015, and is incorporated herein by reference in its entirety.

### TECHNICAL FIELD

These teachings relate generally to additive manufacturing.

### BACKGROUND

Additive manufacturing, sometimes loosely referred to as 3-D printing, comprises a known and active area of endeavor. Additive manufacturing refers generally to any of a variety of processes that manufacture three-dimensional objects by adding in a successive manner constituent raw material. So-called 3-D printers add that content through a plurality of successively-applied layers. In these regards additive manufacturing stands in stark contrast to other manufacturing techniques such as casting or molding, fabrication, stamping, and machining.

Additive manufacturing processes can accommodate a wide variety of raw materials including metals and plastics. In many cases the additive manufacturing process utilizes a corresponding additive manufacturing model. Such a model typically comprises a three-dimensional model of the desired object and is typically created using computer-aided design, a 3-D scanner (to scan an object that is to serve as the basis for the model), or other related techniques. Additive-manufacturing models are typically expressed via corresponding modeling software.

Additive manufacturing is generally viewed as holding great promise, especially for many semi-custom or otherwise specialized purposes. For example, additive manufacturing offers a potentially effective and efficient way to build rare items (such as spare parts for obsolete apparatuses) and otherwise relatively unique items. That said, the promise of additive manufacturing continues to elude many due to such factors as relative unavailability of an additive-manufacturing platform that is appropriate to a particular task or need, the cost of such platforms, and the relative likelihood that a given user will need such a platform frequently enough to justify acquiring, maintaining, and supplying one or more such platforms.

There are also concerns regarding the models themselves. There are some model clearinghouses available, for example, via the Internet but these approaches tend to suffer one or more significant concerns including but not limited to an insufficient capacity to either download or upload such models, facilitating actual use of a given model, effectively controlling usage rights as regards such models, and so forth.

### BRIEF DESCRIPTION OF THE DRAWINGS

The above needs are at least partially met through provision of the method and apparatus to facilitate the use of additive-manufacturing models described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings;

FIG. 3 comprises a flow diagram as configured in accordance with various embodiments of these teachings; and

FIG. 4 comprises a schematic representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a plurality of geographically-distributed retail shopping facilities each have at least one additive-manufacturing platform such as but not limited to a three-dimensional printer. A control circuit provides an additive-manufacturing facilitation service that includes providing a remote user with a choice between (1) providing an additive-manufacturing model to one of the aforementioned additive-manufacturing platforms to permit an item to be manufactured for pickup by the remote user at that corresponding facility and (2) downloading an additive-manufacturing model to permit the remote user to themselves use the additive-manufacturing model (for example, in conjunction with their own additive-manufacturing platform).

These teachings are highly flexible in practice and will accommodate a variety of modifications and/or additions in these regards. For example, by one approach the aforementioned additive-manufacturing facilitation service further includes providing the remote user with a choice to provide a selected additive-manufacturing model to a non-user additive-manufacturing platform that is off-site with respect to any of the plurality of geographically-distributed retail shopping facilities such that the off-site, non-user additive-manufacturing platform uses that additive-manufacturing model to manufacture an item to be provided to the remote user.

As another example, the additive-manufacturing facilitation service can further include providing the remote user with a choice to provide the additive-manufacturing model to an additive-manufacturing platform at one of the plurality of geographically-distributed retail shopping facilities such that the additive-manufacturing platform uses the additive-manufacturing model to manufacture an item that is then shipped to the remote user.

As yet another example, in lieu of the foregoing or in combination therewith, the additive-manufacturing facilitation service includes providing the remote user with an opportunity to upload the additive-manufacturing model or to modify an available additive-manufacturing model. These teachings will also facilitate providing the remote user with an opportunity to create the additive-manufacturing model and/or to permit others to use an additive-manufacturing model that is controlled by the remote user.

As yet another optional approach, these teachings will accommodate providing one or more three-dimensional scanners at one or more of the aforementioned geographically-distributed retail shopping facilities and/or in a mobile platform to permit making such a scanner temporarily available at a location convenient to the user. In such a case the aforementioned additive-manufacturing model can be based upon scanning results provided by such a scanner.

So configured, these teachings facilitate supporting an effective marketplace and more for additive-manufacturing models to thereby permit users to create and/or edit such models, to upload their own models, to download models, to sell or license use of models they control, to render models, and to print such models using any of a variety of additive-manufacturing platforms including such platforms as are provided at each of a plurality of geographically-distributed retail shopping facilities. The aggregation of such capabilities in combination with the likely geographic convenience of retail store-located printers can greatly support a rapid and more ubiquitous adoption and use of additive-manufacturing capabilities.

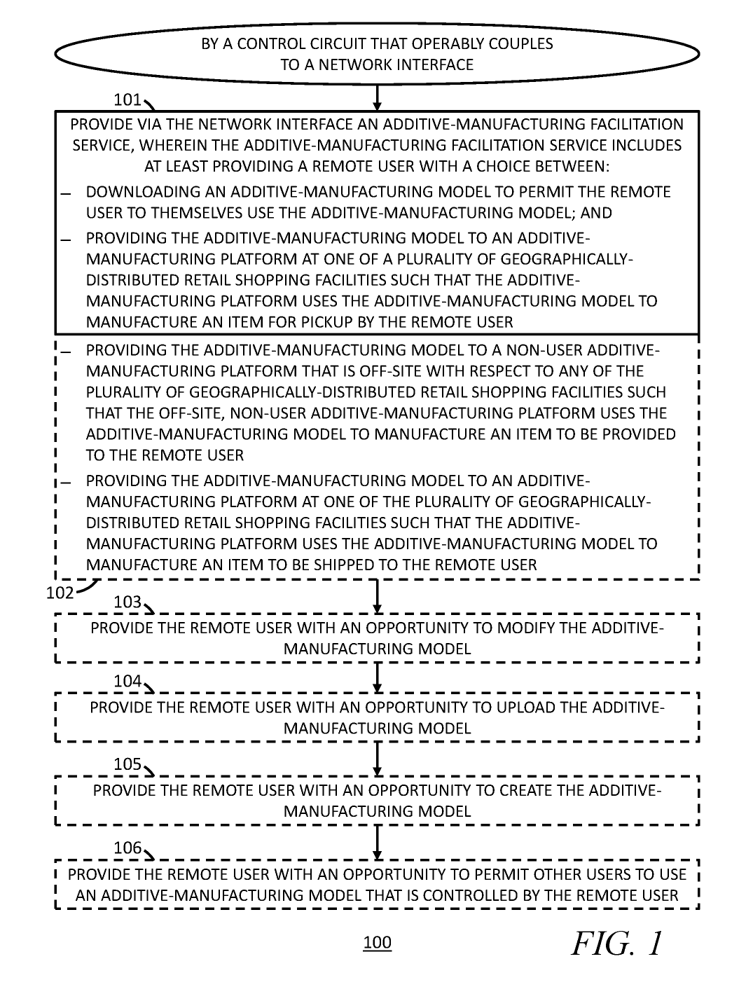

These and other benefits may become clearer upon making a thorough review and study of the following detailed description. Referring now to the drawings, and in particular to FIG. 1, an illustrative process 100 that is compatible with many of these teachings will now be presented. For the sake of an illustrative example it will be presumed here that a control circuit of choice carries out the steps, actions, and functions of this process 100

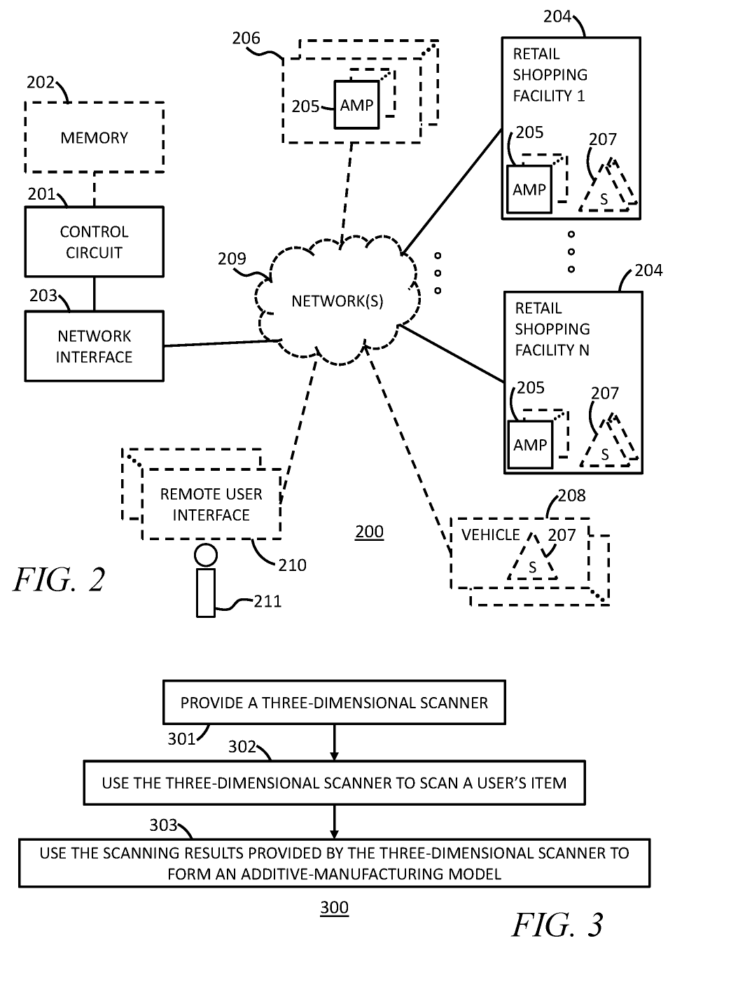

As one illustrative example in such regards, FIG. 2 depicts an apparatus 200 that includes such a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to the aforementioned additive-manufacturing models, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 also operably couples to a network interface 203. So configured the control circuit 201 can communicate with other elements (both within the apparatus 200 and external thereto) via the network interface 203. Network interfaces, including both wireless and non-wireless platforms, are well understood in the art and require no particular elaboration here.

The enabling apparatus 200 also includes a plurality of geographically-distributed retail shopping facilities 204. Each retail shopping facility 204 comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size of format facility, and may include products from one or more merchants. For example, a facility may be a single store operated by one merchant or may be a collection of stores covering multiple merchants such as a mall.

As used herein, the expression “geographically-distributed” shall be understood to refer to a significant physical separation as when the retail shopping facilities 204 are physically discrete and located in different metropolitan areas, counties, states or provinces, or even different countries as compared to one another. This does not mean that some retail shopping facilities 204 cannot share, for example, a same state or even city, but this does mean that this particular plurality of retail shopping facilities 204 are so separated. For the sake of an illustrative example, it will be presumed for the purposes of this discussion that the retail shopping facilities 204 are separated from one another by at least 5 miles.

By one approach, all of the retail shopping facilities 204 are owned and/or controlled, ultimately, by a same enterprise. These teachings will accommodate other approaches in these regards, however.

In this example each of these retail shopping facilities 204 has at least one additive-manufacturing platform 205 such as a three-dimensional printer. Some or all of the retail shopping facilities 204 may in fact have two or more such additive-manufacturing platforms 205 which may or may not be similar or very different from one another. So configured, such a retail shopping facility 204 is configured to offer previously-made items for sale at retail and can also print or manufacture, via additive-manufacturing techniques, items as well.

Although each of the retail shopping facilities 204 includes at least one additive-manufacturing platform 205, if desired, these teachings will optionally accommodate including other additive-manufacturing platforms 205 that are located off-site with respect to any of the aforementioned retail shopping facilities 204. As illustrated in FIG. 2, such off-site additive-manufacturing platforms 205 can be located in one or more buildings 206 that are off-site with respect to any of the geographically-distributed retail shopping facilities 204. These buildings 206 and/or the additive-manufacturing platforms 205 contained therein may or may not be owned and/or controlled by a same enterprise that owns or controls any of the retail shopping facilities 204 as desired.

Also as shown in FIG. 2, one or more of the retail shopping facilities 204 can further include one or more three-dimensional scanners 207. So configured, a facility associate and/or a customer or potential customer can have an item scanned by an available three-dimensional scanner to provide scanning results to form the basis of a corresponding additive-manufacturing model.

Along the same lines, these teachings will also optionally accommodate the apparatus 200 including one or more vehicles 208 that carry one or more such three-dimensional scanners 207. Such a vehicle 208 can comprise essentially any vehicle of choice including terrestrial, waterborne, and airborne vehicles. So configured, the vehicle 208 can carry a three-dimensional scanner 207 to a customer or potential customer remote from any of the retail shopping facilities 204 to again permit the scanning of an item for which the customer or potential customer wishes to have created an additive-manufacturing model.

These various components and elements of the apparatus 200 can communicate with one another via one or more intervening networks 209. This network or networks can comprise any of a variety of wireless and/or non-wireless platforms as are known in the art. By one approach, for example, this network 209 comprises, at least in part, the Internet. In such a case, the aforementioned network interface 203 then comprises, at least in part, an Internet interface.

So configured, such an apparatus 200 will also readily accommodate a large plurality of remote user interfaces 210 including, but not limited to, desktop computers, laptop computers tablet/pad-style computers, so-called smart phones, and so forth. The aforementioned control circuit 201 can communicate with corresponding remote users 211 via such a remote user interface 210 using, for example, a browser-based interface as is exceedingly well understood in the art. As will be described below, so configured, a remote user 211 can access one or more components and/or capabilities of the above-described apparatus 200 in a convenient and secure manner to accomplish any of a wide variety of actions as regards additive-manufacturing models.

With continued reference to FIGS. 1 and 2, at block 101 the aforementioned control circuit 201 provides, via the aforementioned network interface 203, an additive-manufacturing facilitation service. As will be elaborated upon below, this additive-manufacturing facilitation service can comprise a large number of related and/or disparate services. By one approach, however, this additive-manufacturing facilitation service includes at least providing a remote user 211 with a choice between at least two options regarding additive-manufacturing models.

The first option comprises downloading an additive-manufacturing model to permit the remote user to themselves use the additive-manufacturing model. The control circuit 201 might, by one approach, access the requested additive-manufacturing model in the aforementioned memory 202. By another approach, in lieu of the foregoing or in combination therewith, the control circuit 201 may access a third-party remote server to locate and acquire the requested additive-manufacturing model. Downloading of the additive-manufacturing model to the remote user 211 can occur via the aforementioned network 209 and remote user interface 210. The remote user 211 may themselves use the downloaded additive-manufacturing model in any of a variety of ways. Examples include rendering the model (for example, as an image on a display), printing the model, editing the model, and so forth.

The second option comprises providing the requested or otherwise identified or selected additive-manufacturing model to an additive-manufacturing platform 205 at one of the plurality of geographically-distributed retail shopping facilities 204 such that the additive-manufacturing platform 205 uses the additive-manufacturing model to manufacture an item for pickup by the remote user 211 at that particular retail shopping facility 204. This option can help the remote user 211 make suitable use of a particular additive-manufacturing model even when the remote user 211 does not themselves own or otherwise have convenient access to a suitable additive-manufacturing platform. This option can be particularly convenient and powerful when the remote user 211 resides or is otherwise located relatively near one of the retail shopping facilities 204 (such as within a few miles such as 1 mile, 2 miles, 5 miles, or the like).

When exercising this second option, the control circuit 201 can determine an appropriate pickup time by when the corresponding item will have been manufactured and thereby become available for pickup. The control circuit 201 can then communicate that determined pickup time to the remote user 211. In lieu of the foregoing or in combination therewith, the control circuit 201 can provide an alert (such as a text message or an email) to the remote user 211 when the item becomes available for pickup.

As noted above, a retail shopping facility 204 can include a customer service area (where, for example, customers can return previously-purchased items for a refund). By one approach the manufactured item can be made available for pickup at such a customer service area. In other cases the retail shopping facility 204 may include a photo center where customers can arrange for various photo services and products. In that case, if desired, the manufactured item can be made available for pickup at such a photo center. These teachings will accommodate, however, a wide variety of other approaches in these regards. By one approach, for example, a portion of the retail shopping facility 204 can be dedicated to serving as a pickup center for items manufactured per these teachings.

By one approach the manufactured item can be presented as-is to the remote user 211. These teachings will also accommodate, however, placing the manufactured item in a suitable container (either as a matter of standard practice or at the request of the remote user 211). These teachings would also accommodate, if desired, gift wrapping the manufactured item at the remote user's request.

In addition to the foregoing, or in lieu thereof, the additive-manufacturing facilitation service can offer one or more other options as desired. Block 102 provides two salient examples in these regards.

As one option, the additive-manufacturing facilitation service includes the option of providing a selected additive manufacturing model to a non-user additive-manufacturing platform 205 that is off-site 206 with respect to any of the retail shopping facilities 204. In this case the off-site, non-user additive-manufacturing platform 205 uses the additive-manufacturing model to manufacture an item to be provided to the remote user 211. Such an approach can be useful, for example, when the off-site additive-manufacturing platform 205 constitutes a particularly expensive or technologically unusual platform (employing, for example, a relatively unusual manufacturing material and/or capable of particularly high/fine manufacturing resolution). An item manufactured by an off-site additive-manufacturing platform 205 can be made available to the remote user 211 at that off-site facility 206, or can be shipped directly to the remote user 211, or can be made available for pickup at a particular one of the retail shopping facilities 204 (for example, a particular facility that is closest to the remote user or where the remote user 211 has specified a particular remote shopping facility 204 in these regards).

Block 102 also illustrates an optional option of providing the additive-manufacturing model to an additive-manufacturing platform 205 at one of the retail shopping facilities 204 such that the additive-manufacturing platform 205 uses the additive-manufacturing model to manufacture an item that is then shipped to the remote user 211 rather than made available for pickup at the retail shopping facility 204 itself. By one approach the remote user 211 is given an option in these regards. By another approach this shipping option is mandatory when one or more vetting criteria are met.

These teachings, and this process 100, are highly flexible in practice. FIG. 1 offers a number of illustrative examples in these regards. For example, at optional block 103 the additive-manufacturing facilitation service can include providing the remote user with an opportunity to modify an additive-manufacturing model. These modifications can vary as desired. Examples include modifying one or more dimensions of the model, inclusion or exclusion of particular components or elements of the model, colors or materials, and so forth. These teachings will accommodate facilitating such modifications in various ways in accordance with the needs and/or opportunities that tend to characterize a given application setting. By one approach, for example, the remote user 211 downloads the additive-manufacturing model and makes the desired modifications using their own resources. The modified model can then be uploaded and used as described herein. By another approach, the remote user 211 modifies a particular additive-manufacturing model via an on-line editing capability that the control circuit 211 provides, for example, via a browser-based interface.

At block 104 this process 100 can optionally provide the remote user 211 with an opportunity to upload a particular additive-manufacturing model that can then be employed as described herein. This can include additive-manufacturing models that the remote user 211 has designed themselves as well as additive-manufacturing models that the remote user 211 has acquired through other channels.

At block 105 this process 100 can optionally provide the remote user with an opportunity to create the additive-manufacturing model to be employed as described herein. This activity can include, for example, uploading scanning results provided by a three-dimensional scanner 207 as described above. As a more specific example in these regards, and referring momentarily to FIG. 3 in conjunction with FIG. 2, a corresponding process 300 provides a three-dimensional scanner 207 at block 301. This can comprise providing a three-dimensional scanner 207 at a retail shopping facility 204 or in a vehicle 208, all as described above.

At block 302 the three-dimensional scanner 207 is used to scan a user's item. The specifics of this activity will of course vary with respect to both the particulars of the three-dimensional scanner being employed as well as the particulars of the item to be scanned. Three-dimensional scanning of an item comprises a well understood area of prior art endeavor that requires no further elaboration here.

At block 303, this process 300 then provides for using the scanning results provided by the three-dimensional scanner 207 to form a corresponding additive-manufacturing model. Again, forming an additive-manufacturing model as a function of an available three-dimensional scan comprises a well understood area of prior art endeavor and hence no further details are provided here for the sake of brevity.

As noted above, these teachings can accommodate, if desired, permitting a remote user 211 to upload an additive-manufacturing model. By one approach, the uploaded model can be retained only so long as is necessary to complete the manufacturing of a corresponding item for the remote user 211. By another approach, if desired, these teachings will support retaining such an uploaded model (or a model that the remote user 211 has otherwise created within the apparatus 200) for a longer period of time.

By one approach, the remote user 211 can be given the choice of having a particular additive-manufacturing model so retained in exclusivity for the remote user 211 only. In that case the additive-manufacturing model can only be further accessed or otherwise utilized at the behest of the remote user 211. These teachings will also support, however, providing the remote user 211 with other options in these regards. For example, at block 106, this additive-manufacturing facilitation service provides the remote user 211 with an opportunity to permit other users to use an additive-manufacturing model that is controlled by the remote user 211. The specifics of this “control” can vary as desired. By one approach, for example, the remote user 211 can simply require that a third-party pay some fee when using the controlled additive-manufacturing model. That fee could then be provided by the control circuit 201 back to the remote user 211 (perhaps less some facilitation service fee).

These teachings will accommodate other dimensions of “control” if desired. As one example, a remote user 211 may designate that a particular additive-manufacturing model be available free of charge but only when used by other members of a particular affinity group to which the remote user 211 belongs (such as a hobbyist club in a particular town). As another example, a remote user 211 may specify a particular passcode that, when entered by a third party remote user, will permit free usage of the additive-manufacturing model. Other possibilities in these regards can certainly be accommodated.

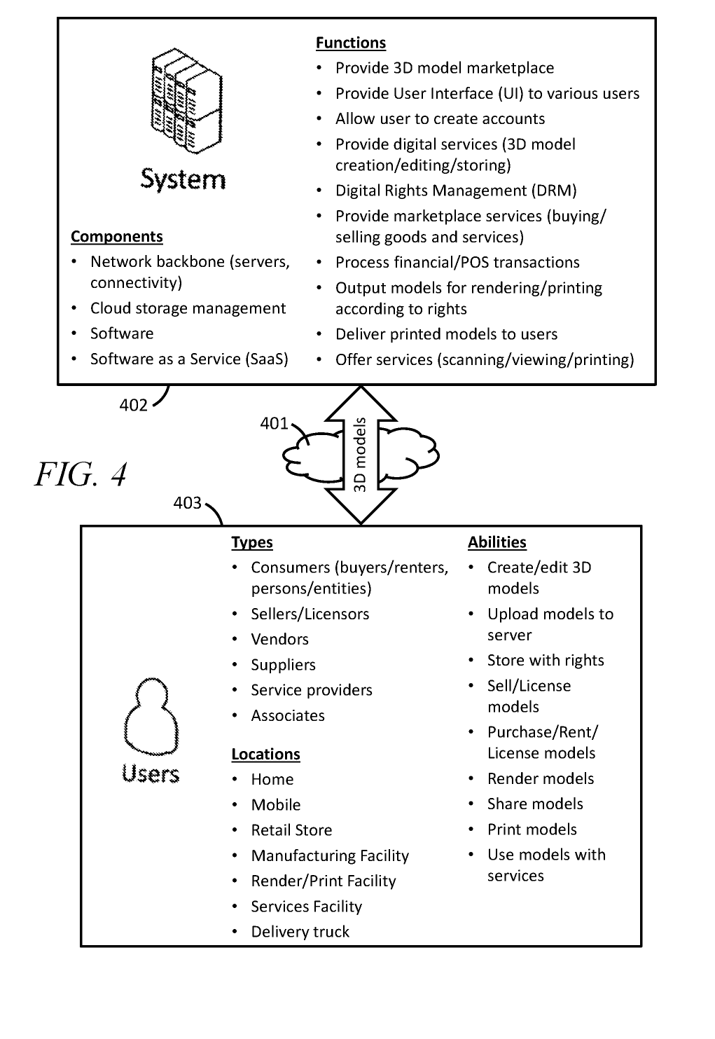

Such an additive-manufacturing facilitation service can be as simple or as richly appointed as desired. FIG. 4 illustrates schematically various ways by which a collection of additive-manufacturing models 401 are administered and utilized by a facilitation system 402 on behalf of a universe of remote users 403. Using components such as a suitable network backbone, cloud storage management, implementing software, and/or software as a service such a system 402 can provide a virtual marketplace for additive-manufacturing models. The facilitation capabilities can include but are not limited to providing a suitable user interface, permitting or requiring users of the service to create corresponding accounts, providing a variety of digital services including the creation, editing, and/or storing of additive-manufacturing models, and the management of digital rights as correspond to such models.

Such an additive-manufacturing facilitation service can further serve to provide a variety of marketplace services including the buying and selling of corresponding goods and services, processing a variety of related financial transactions, outputting additive-manufacturing models to remote users and/or additive-manufacturing platforms for corresponding rendering or printing in accordance with corresponding rights, providing resultant manufactured items to users, and a variety of other related services.

The users 403 themselves can comprise a wide population of user types including ordinary consumers, model sellers and licensors, related vendors and suppliers, other service providers, and even the associates of the aforementioned retail shopping facilities 204. It will be understood that these users, though remote from the aforementioned additive-manufacturing platforms 205, can otherwise be located essentially anywhere. Examples include their residences, their vehicles (including delivery vehicles), other retail stores, other manufacturing or service facilities, and so forth.

So configured, such an additive-manufacturing facilitation service enables such users to create and/or edit additive-manufacturing models, to upload models, to arrange for such models to be stored (with or without a corresponding rights and limitations/conditions regarding use), sell or license uploaded models, purchase, rent, or license the models of others, render visual representations of models, share models (for example, with an affinity group), create items via additive-manufacturing techniques, and so forth.

It will also again be understood and emphasized that these teachings are highly flexible in practice. As one example in these regards, when an item to be manufactured includes multiple components, and where some of those components are comprised of differing materials (such as plastic for one component and metal for another component) these teachings will accommodate using additive-manufacturing platforms 205 at different retail shopping facilities 204 as appropriate or necessary to manufacture the various components of the item. The aggregation of those components, either in a singulated format or in an assembled format, can then be made available for pickup by the remote user 211 at a particular one of the retail shopping facilities 204 or shipped to the remote user's address of choice.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a plurality of geographically-distributed retail shopping facilities, each having at least one additive-manufacturing platform;
a network interface;
a control circuit operably coupled to the network interface and configured to provide via the network interface an additive-manufacturing facilitation service, wherein the additive-manufacturing facilitation service includes at least providing a remote user with a choice between:
downloading an additive-manufacturing model to permit the remote user to themselves use the additive-manufacturing model; and
providing the additive-manufacturing model to an additive-manufacturing platform at one of the plurality of geographically-distributed retail shopping facilities such that the additive-manufacturing platform uses the additive-manufacturing model to manufacture an item for pickup by the remote user.

2. The apparatus of claim 1 wherein the at least one additive-manufacturing platform comprises a three-dimensional printer.

3. The apparatus of claim 1 wherein the network interface comprises, at least in part, an Internet interface.

4. The apparatus of claim 1 wherein the control circuit is configured to provide the additive-manufacturing facilitation service via a browser-based interface.

5. The apparatus of claim 1 wherein the additive-manufacturing facilitation service further includes providing the remote user with a choice to provide the additive-manufacturing model to a non-user additive-manufacturing platform that is off-site with respect to any of the plurality of geographically-distributed retail shopping facilities such that the off-site, non-user additive-manufacturing platform uses the additive-manufacturing model to manufacture an item to be provided to the remote user.

6. The apparatus of claim 1 wherein the additive-manufacturing facilitation service further includes providing the remote user with a choice to provide the additive-manufacturing model to an additive-manufacturing platform at one of the plurality of geographically-distributed retail shopping facilities such that the additive-manufacturing platform uses the additive-manufacturing model to manufacture an item to be shipped to the remote user.

7. The apparatus of claim 1 wherein the additive-manufacturing facilitation service includes providing the remote user with an opportunity to modify the additive-manufacturing model.

8. The apparatus of claim 1 wherein the additive-manufacturing facilitation service includes providing the remote user with an opportunity to upload the additive-manufacturing model.

9. The apparatus of claim 1 wherein the additive-manufacturing facilitation service includes providing the remote user with an opportunity to create the additive-manufacturing model.

10. The apparatus of claim 1 wherein the additive-manufacturing facilitation service includes providing the remote user with an opportunity to permit other users to use an additive-manufacturing model that is controlled by the remote user.

11. The apparatus of claim 1 wherein the plurality of geographically-distributed retail shopping facilities each further has at least one three-dimensional scanner, and wherein the additive-manufacturing model is based upon scanning results provided by at least one of these three-dimensional scanners.

12. The apparatus of claim 1 wherein the additive-manufacturing facilitation service includes controlling distribution and use of additive-manufacturing models in observance of corresponding legal rights.

13. A method comprising:
by a control circuit that operably couples to a network interface:
provide via the network interface an additive-manufacturing facilitation service, wherein the additive-manufacturing facilitation service includes at least providing a remote user with a choice between:
downloading an additive-manufacturing model to permit the remote user to themselves use the additive-manufacturing model; and
providing the additive-manufacturing model to an additive-manufacturing platform at one of a plurality of geographically-distributed retail shopping facilities such that the additive-manufacturing platform uses the additive-manufacturing model to manufacture an item for pickup by the remote user.

14. The method of claim 13 wherein providing a remote user with a choice further comprises:
providing the remote user with a choice to provide the additive-manufacturing model to a non-user additive-manufacturing platform that is off-site with respect to any of the plurality of geographically-distributed retail shopping facilities such that the off-site, non-user additive-manufacturing platform uses the additive-manufacturing model to manufacture an item to be provided to the remote user.

15. The method of claim 13 wherein providing a remote user with a choice further comprises:
providing the remote user with a choice to provide the additive-manufacturing model to an additive-manufacturing platform at one of the plurality of geographically-distributed retail shopping facilities such that the additive-manufacturing platform uses the additive-manufacturing model to manufacture an item to be shipped to the remote user.

16. The method of claim 13 wherein providing the additive-manufacturing facilitation service further comprises:
providing the remote user with an opportunity to modify the additive-manufacturing model.

17. The method of claim 13 wherein providing the additive-manufacturing facilitation service further comprises:
providing the remote user with an opportunity to upload the additive-manufacturing model.

18. The method of claim 13 wherein providing the additive-manufacturing facilitation service further comprises:
providing the remote user with an opportunity to create the additive-manufacturing model.

19. The method of claim 13 wherein providing the additive-manufacturing facilitation service further comprises:
providing the remote user with an opportunity to permit other users to use an additive-manufacturing model that is controlled by the remote user.

20. The method of claim 13 wherein providing the additive-manufacturing facilitation service further comprises:
using scanning results provided by a three-dimensional scanner located at one of the plurality of geographically-distributed retail shopping facilities to form the additive-manufacturing model.
